(19) United States
(12) Patent Application Publication
(10) Pub. No.: US 2009/0025328 A1
(43) Pub. Date: Jan. 29, 2009

(54) MECHANICAL PLUG AND METHOD FOR USING THE SAME

(75) Inventors: MATTHEW HEMMINGER, NASHUA, IA (US); AARON WIEBKE, CEDAR RAPIDS, IA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ELITE PRODUCTS, LLC, NASHUA, IA (US)

(21) Appl. No.: 12/022,689

(22) Filed: Jan. 30, 2008

Related U.S. Application Data
(60) Provisional application No. 60/898,687, filed on Feb. 1, 2007.

(51) Int. Cl. E04G 17/06; E04F 19/00; F16B 13/04; F16B 13/14; E04G 23/02

(52) U.S. Cl. 52/514; 52/741.4

(57) ABSTRACT

A plug designed to seal an opening formed in a concrete wall. The plug comprises a main body portion, a first end, and a second end wherein the first end and second end are combined by a bolt having a fastener on one end. Washers are combined with the bolt on each end of the plug. The plug has a first diameter wherein it can be inserted into the opening and a second diameter wherein it plugs the opening in the wall. The plug is moved from its first position to its second position by tightening the fastener thereby squeezing the plug between the two washers. This tightening causes an expansion of the plug to its second position, increasing its diameter inside the opening and forming a seal between the plug and the wall of the opening.

This application claims priority under 35 USC 119 to Provisional Patent Application Ser. No. 60/898,687 filed on Feb. 1, 2007, the contents of which are hereby incorporated by reference.

### BACKGROUND OF THE INVENTION

In the construction of houses, water/wastewater treatment tanks, and other structures, widespread use is made of poured concrete for foundations. Typically, concrete foundations and tank walls are formed in wooden or steel forms into which the concrete is poured. The forms are secured in spaced relation by steel tension rods (tie rods). After the concrete hardens (sets), the tie rods and forms are removed leaving the concrete structure with a number of openings extending therethrough. These openings result in an unacceptable construction if the function of the concrete structure requires the creation of a barrier against water and pests.

Many different types of plugs have been developed to plug the types of openings that are left in concrete structures after tie rods are removed. Some types of existing plugs are made from a resilient material that is forced into the opening and then expands to create a plug. These types of plugs are more fully disclosed in U.S. Pat. Nos. 3,390,498, Roy et al, issued Jul. 2, 1968, and 4,016,696, Mess et al, issued Apr. 12, 1977. However, these types of plugs can become loose or even ejected from the openings if a large amount of water pressure acts on the opening. Therefore, to help secure resilient plugs in the openings, manufacturers began making tapered tie rods. When the tapered tie rods are removed from the concrete structures, the resulting openings are also tapered. The resilient plugs are inserted into the larger diameter end of the opening so that any additional pressure from the larger diameter opening side of the concrete structure would simply drive the plug further into the narrowing opening causing a better seal.

Although the system of using resilient plugs in tapered openings works well in some applications, the system has several disadvantages. One problem is that the tapered tie rods are required to be aligned so that their larger diameter side is facing the direction that is more likely to receive higher pressure. This results in increased construction costs since each tie rod must be analyzed to determine the direction of its taper. A leak could result if one tie rod was backwards or if pressure was applied to the small diameter side of the opening. Another problem is that the system requires that the resilient plugs are inserted into the larger diameter opening (i.e. the resilient plugs cannot be inserted into the end of the opening having the smaller diameter because the plugs are too big). Yet another problem with the use of the resilient plugs with tapered openings system relates to fixing leaks that occur after the concrete structure is created. If the concrete structure is buried underground such as the foundation of a house or if the concrete structure is a tank full of water, replacing a resilient plug can be a monumental task that may require digging up part of the house's foundation or draining the tank in order to gain access to the opening's larger diameter end to insert a new plug therein.

Therefore, there is a need for a plug that provides an excellent seal and is easy to install and replace.

### SUMMARY OF THE INVENTION

In accordance with the present invention, a mechanical plug is provided to seal an opening in a structure. Although the plug may be used to seal any suitable opening, this specification discusses the use of the plug in relation to sealing an opening created by the removal of a reusable tie rod in a concrete wall. The plug of the present invention is inexpensive in construction, easy to install and replace, and provides a superior result when compared with other devices and methods that are currently available.

The plug comprises a main body portion, a first end, and a second end. The main body portion is a cylindrically shaped resilient sleeve. The first end and second end are combined by a bolt having a fastener on one end. In one embodiment, washers are combined with the bolt on each end of the plug. The plug has a first position having a first diameter wherein the plug can be inserted into the opening and a second position having a second diameter wherein the plug's diameter is expanded to seal the opening. The plug is moved from its first position to its second position by tightening the fastener thereby squeezing the plug between the two washers. This tightening causes an expansion of the plug main body portion to its second position, increasing its diameter inside the opening and forming a seal between the plug and the wall of the opening.

### BRIEF DESCRIPTION OF THE DRAWINGS

FIG. 1 is a cross-sectional view of a tapered tie rod extending through a concrete wall and associated formwork;

FIG. 2 is a view similar to FIG. 1 wherein the tie rod has been removed to leave a tapered opening in the concrete wall;

FIGS. 3 and 4 are cross-sectional views showing the installation of an embodiment of the mechanical plug into the tapered opening of a concrete wall wherein the plug's bolt comprises a threaded portion combined with nut;

FIG. 5 is a cross-sectional view showing grout applied over the plug in the opening;

FIG. 6 is a cross-sectional view showing installation of an embodiment of the mechanical plug into a non-tapered opening wherein the plug comprises ribs; and

FIG. 7 is a side view of an embodiment of the mechanical plug wherein the plug's bolt comprises barbs for interfering with a locking ring.

### DETAILED DESCRIPTION OF THE INVENTION

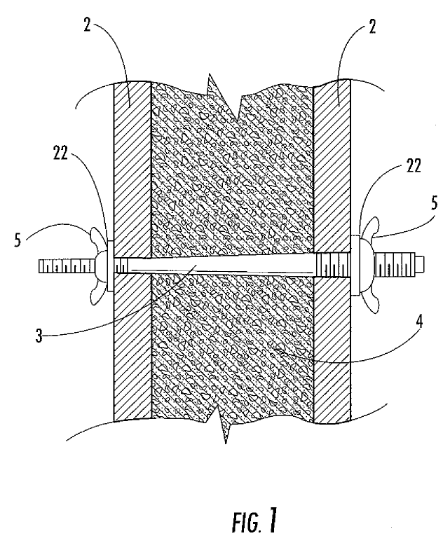

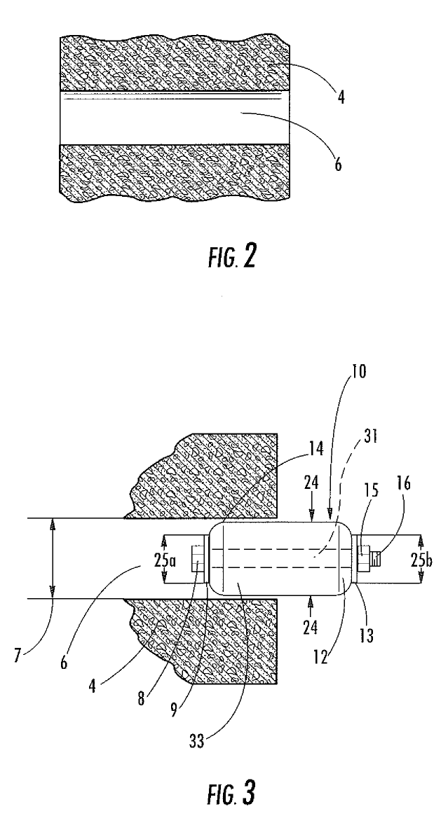

FIG. 1 of the drawings shows a typical wall construction utilizing a reusable tapered tie rod 3. A pair of wall forms 2 are held in place by the tie rod 3 preventing the wall forms 2 from spreading apart when concrete 4 is poured between them. Threaded on opposite ends of the tie rod 3 are washers 22 or the like, with threaded wing nuts 5 or the like used to fasten and secure the tie rod 3 and the formwork 2. The tie rod 3 preferably comprises a smooth tapered main body section 3 which permits withdrawal of the tie rod 3 during removal of the formwork after the concrete wall 4 is poured, thereby creating a smooth surfaced opening 6 in the concrete wall 4, as shown in FIG. 2.

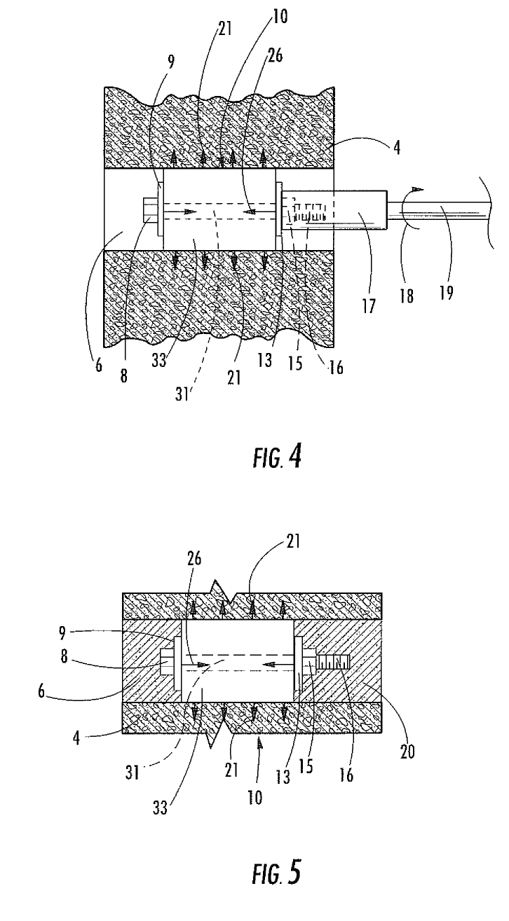

After removal of the tie rod 3, the resulting opening 6 in the concrete wall 4 must be sealed to prevent water, moisture, dirt, or pests from being able to penetrate through the wall 4. To seal this opening 6, in accordance with the present invention, a plug 10 is provided. Different embodiments of the plug 10 are shown in FIGS. 3, 6, and 7. The plug 10 generally comprises a main body portion having a first end 12 and a second end 14. The main body portion of the plug 10 is a cylindrically shaped resilient sleeve 33 that is preferably comprised of a rubber such as Neoprene, EPDM, Nitrile, or Silicone, however any other suitable material may be used. If desired, the plug 10 may be formed of a material specified for the application and colored approximately the same color as the concrete wall 4 within which it is to be received.

In one embodiment, the plug 10 comprises a hollow center portion adapted to receive a bolt 31 or some other suitable connecting member. The bolt 31 has a flange 8 at one end and a threaded portion 16 at the other end which is adapted to receive a fastener such as a threaded nut 15. The bolt 31 may be fitted with members 9, 13 slidably mounted at each end. The members 9, 13 may be washers or other suitable structures capable of distributing the load from the nut 15 or flange 8 to the main body portion of the plug 10.

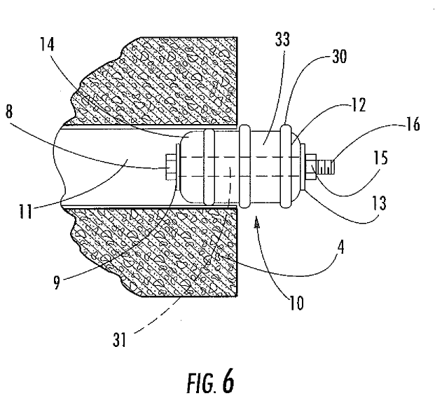

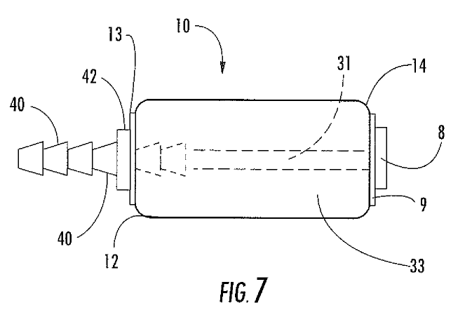

It is unnecessary to force the plug 10 into the opening 6 in the wall 4 to provide a good seal and prevent dislodgement. One reason for this is because the plug 10 comprises a first position having a first diameter wherein the plug 10 can be inserted into the opening 6 and a second position having a second diameter wherein the plug 10 seals the opening 6. In its second position, the sleeve's 33 diameter is expanded to block and seal the opening 6 in the wall 4. The dimensions of the plug 10 are selected such that the outside dimension of the sleeve 33 (indicated by the arrows 24 in FIG. 3) is smaller than the inside dimension of the opening 6 (indicated by the arrow 7 in FIG. 3) when the plug 10 is in its first position (FIGS. 3 and 6). In its second position (FIGS. 4 and 5), the diameter of the sleeve 33 is increased to approximate the diameter of the opening 6 and create a seal.

In the embodiments shown in FIGS. 3, 6 and 7, the first end 12 and second end 14 of the sleeve 33 are tapered when the plug 10 is in its first position. As shown in FIG. 3, the first and second ends 12, 14 of the sleeve 33 each taper from a first diameter (indicated by arrows 25a and 25b) toward the larger sleeve 33 diameter (indicated by arrows 24). The taper helps the sleeve 33 expand from its first position to its second position without deforming the sleeve 33. As members 9, 13 are forced toward each other, the tapers on the ends 12, 14 of the sleeve 33 help the plug 10 expand its diameter along the length of the sleeve 33 instead of only at the point where the members 9, 13 contact the ends 12, 14 of the sleeve 33.

Actuating the plug 10 between its first and second positions is seen by comparing FIGS. 3 and 4. The plug 10 is first inserted to a desired depth within the opening 6. The plug 10 can be used in tapered openings 6 as shown in FIGS. 1 and 3 and non-tapered openings 11 as shown in FIG. 6. If the opening 6 is tapered and the plug 10 is being inserted from the opening's 6 larger diameter side, then the plug 10 is adjusted so that its diameter allows it to be inserted into the opening 6 to a predetermined depth (usually several inches) before its outer surface contacts the walls of the tapered opening 6. If the opening is tapered and the plug 10 is being inserted from the opening's 6 smaller diameter side, then plug 10 is adjusted so that it is small enough to fit inside the opening 6. If the plug cannot be made small enough to fit inside the desired opening 6, 11, a plug 10 with a smaller initial (first position) diameter can be used. In other words, even though the plug's 10 diameter can be adjusted, the plug 10 can be made in various sizes to fit different diameter openings 6.

After the plug 10 is set at the desired depth in the opening 6, turning pressure (indicated by arrow 18 in FIG. 4) is applied to the flange 8 or nut 15 by a socket 17, wrench, hand, or other suitable means. The turning energy 18 forces the members 9, 13 towards each other (indicated by arrows 26 in FIG. 4) thereby squeezing the sleeve 33 between the members 9, 13 and increasing the plug's 10 diameter (indicated by arrows 21 in FIG. 4). Thereafter, the plug 10 forms a seal between the plug 10 and the walls of opening 6.

In an alternate embodiment shown in FIG. 7, the bolt 31 comprises a plurality of barbs 40 at one end (instead of threads 16). A fastener such as a ratchet or locking ring 42 is combined with the bolt 31 over the barbs 40. The locking ring 42 has an opening with a diameter that is smaller than the diameter of barbs 40 so that the barbs 40 can pass through the locking ring 42 in a first direction but not in a second direction. This allows the user to compress the sleeve 33 between the locking ring 42 and the flange 8 to increase the sleeve's 33 diameter by forcing the locking ring 42 over the barbs 40 toward the flange 8. A hand tool can be used to grasp the end of the barbs 40 and place the plug 10 into the desired opening 6. The hand tool can then be used to force the locking ring 42 over the barbs 40 towards the flange 8 to move the plug 10 to its second position and seal the opening 6.

If desired, the plug 10 can be positioned at any depth within the opening 6 and sealed at one or both ends with grout 20 as shown in FIG. 5. If preferred, the plug 10 can be inserted to a point where its first end 12 or second end 14 is flush with the wall face to create a smooth unbroken wall face. Alternatively, filling the opening 6 with grout 20 can also create a smooth unbroken wall face regardless of how far the plug 10 is placed in the opening 6.

In the embodiment shown in FIGS. 3 and 4, the outer surface of the sleeve 33 is semi-smooth, therefore, facilitating insertion of the plug 10 into the opening 6. FIG. 6 shows an alternate embodiment wherein the sleeve 33 comprises one or more ribs 30. The ribs 30 have a larger diameter than the remainder of the plug 10. This embodiment is preferably used in openings 11 that are not tapered and/or in openings 11 having potentially slippery walls, such as PVC pipe. In the tapered opening 6 embodiments described above, it is easier for the outer semi-smooth surface of the sleeve 33 to frictionally engage the wall of the opening 6 so the plug 10 does not slip or spin as the pressure 18 is applied to move the plug 10 to its second position. When the plug 10 is used in non-tapered openings 11 and/or in a PVC pipe, however, the ribs 30 help the sleeve 33 engage the wall of the opening 6 as the turning pressure 18 is applied so the plug 10 does not slip or spin inside the opening 6.

If desired, multiple plugs 10 can be used to seal a single opening 6 regardless of whether the opening 6 is tapered or not. Multiple plugs 10 may be used since each plug 10 can be adjusted to its own independent diameter.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. A mechanical plug for sealing an opening having a fixed diameter, said plug comprising:
a cylindrically shaped resilient sleeve having a first end and a second end;
a bolt having a first end and a second end that extends through the sleeve to combine the sleeve's first and second ends, wherein the bolt comprises a flange on its first end and a fastener on its second end that is movable relative to the bolt;
wherein moving the fastener axially along the bolt towards the flange exerts a compressive force on the resilient sleeve that radially expands the resilient sleeve from a first diameter in which the plug can be inserted into the opening to a second diameter that is larger than the first diameter and approximates the diameter of the opening to seal the opening;
a plurality of ribs on the sleeve's outer surface to help keep the plug from rotating and slipping inside the opening as the plug is expanded from its first diameter to its second diameter.

2. The plug of claim 1 further comprising a washer slidably mounted on the bolt between the fastener and the sleeve to help distribute the load from the nut to the sleeve.

3. The plug of claim 1 further comprising a washer slidably mounted on the bolt between the flange and the sleeve to help distribute the load from the flange to the sleeve.

4. The plug of claim 1 wherein the bolt comprises threads on its second end and wherein the fastener is a nut threadably combined with the threads on the bolt's second end.

5. The plug of claim 1 wherein the bolt comprises barbs on its second end and wherein the fastener is a locking ring.

6. A mechanical plug for sealing an opening having a fixed diameter, said plug comprising:
a cylindrically shaped resilient sleeve having a first end and a second end;
a bolt having a first end and a second end that extends through the sleeve to combine the sleeve's first and second ends, wherein the bolt comprises a flange on its first end and a fastener on its second end that is movable relative to the bolt;
wherein moving the fastener axially along the bolt towards the flange exerts a compressive force on the resilient sleeve that radially expands the resilient sleeve from a first diameter in which the plug can be inserted into the opening to a second diameter that is larger than the first diameter and approximates the diameter of the opening to seal the opening;
wherein the sleeve's first end and second end each have a tapered portion that helps the plug radially expand from its first position to its second position without deforming the sleeve.

7. The plug of claim 6 wherein the bolt comprises threads on its second end and wherein the fastener is a nut threadably combined with the threads on the bolt's second end.

8. The plug of claim 6 wherein the bolt comprises barbs on its second end and wherein the fastener is a locking ring.

9. A method for plugging an opening in a cement structure formed between forms connected by tie rods, the method using a mechanical plug having a cylindrically shaped resilient sleeve with a first end and a second end, wherein the first end and second end are combined by a bolt having a first end and a second end with a fastener combined with the bolt's first end and a flange combined with the bolt's second end, said method comprising:
removing a tie rod from the cement structure to create the opening;
inserting the plug a predetermined distance into the opening wherein the diameter of the plug is a first diameter that is smaller than the diameter of the opening;
sealing the opening by moving the fastener axially along the bolt towards the flange to exert a compressive force on the resilient sleeve that radially expands the resilient sleeve from its first diameter to a second diameter that is larger than the first diameter and approximates the diameter of the opening.

10. The method of claim 9 wherein the bolt comprises threads on its second end and wherein the fastener is a nut threadably combined with the threads on the bolt's second end.

11. The method of claim 10 wherein the plug is expanded by tightening the nut on the bolt thus forcing the first end and second end closer together and making the diameter of the resilient sleeve larger.

12. The method of claim 9 wherein the opening is tapered thereby having a larger diameter end and a smaller diameter end.

13. The method of claim 12 wherein the plug is inserted into the tapered opening's larger diameter end.

14. The method of claim 12 wherein the plug is inserted into the tapered opening's smaller diameter end.

15. The method of claim 9 wherein the opening is not tapered.

16. The method of claim 9 further comprising the step of filling a portion of the opening with grout after insertion of the plug.

17. The method of claim 9 further comprising the step of inserting a second plug into the opening and sealing the opening by expanding the second plug to a diameter that approximates the diameter of the opening.

18. The method of claim 9 wherein the bolt comprises barbs on its second end and wherein the fastener is a locking ring.

19. A method for plugging a tapered opening having a larger diameter end and a smaller diameter end using a mechanical plug having a cylindrically shaped resilient sleeve with a first end and a second end, wherein the first end and second end are combined by a bolt having a first end and a second end with a fastener combined with the bolt's first end and a flange combined with the bolt's second end, said method comprising:
inserting the plug a predetermined distance into the smaller diameter end of the opening wherein the diameter of the plug is a first diameter that is smaller than the smaller diameter end of the opening;
sealing the opening by expanding the plug to a second diameter that is larger than its first diameter and that approximates the diameter of the opening.

20. The method of claim 19 wherein the bolt comprises threads on its second end and wherein the fastener is a nut threadably combined with the threads on the bolt's second end.

21. The method of claim 20 wherein the plug is expanded by tightening the nut on the bolt thus forcing the first end and second end closer together and making the diameter of the resilient sleeve larger.

22. The method of claim 19 wherein the bolt comprises barbs on its second end and wherein the fastener is a locking ring.

23. The method of claim 19 further comprising the step of filling a portion of the opening with grout after insertion of the plug.
